(19) United States
(12) Patent Application Publication
(10) Pub. No.: US 2024/0422051 A1
(43) Pub. Date: Dec. 19, 2024

(54) DEVICE AND SYSTEM FOR COMMUNICATION NETWORK MANAGEMENT AND COMMUNICATION FAILURE RESPONSE SERVICE BASED ON PROCESS INFORMATION AT CONSTRUCTION SITE, METHOD OF PROVIDING SAME SERVICE, AND NON-VOLATILE RECORDING MEDIUM IN WHICH COMPUTER PROGRAM FOR PROVIDING SAME SERVICE IS RECORDED

(71) Applicant: SK Planet Co., Ltd., Seongnam-si (KR)

(72) Inventor: Woo Yong KIM, Seoul (KR)

(21) Appl. No.: 18/823,313

(22) Filed: Sep. 3, 2024

Related U.S. Application Data
(63) Continuation of application No. PCT/KR2023/008190, filed on Jun. 14, 2023.

(30) Foreign Application Priority Data
Dec. 9, 2022 (KR) 10-2022-0171600
Dec. 9, 2022 (KR) 10-2022-0171604

(51) Int. Cl. H04L 41/0659; G06Q 50/08; H04L 41/0677

(52) U.S. Cl. CPC H04L 41/0659; G06Q 50/08; H04L 41/0677

(57) ABSTRACT

The present disclosure provides: a device and system for a communication network management and communication failure response service based on process information at a construction site, the device and method creating a strategy for responding to a communication failure generated in accordance with a work schedule at a construction site and making it possible to respond to a failure through only a failure response strategy using a current communication network even though it is difficult to solve the failure; a method of providing the service; and a non-volatile recording medium in which a computer program for providing the service is recorded.

### CROSS REFERENCE TO RELATED APPLICATIONS

The application is a bypass continuation of International PCT Application No. PCT/KR2023/008190, filed on Jun. 14, 2023, which claims priority to Republic of Korea Patent Application No. 10-2022-0171600 filed on Dec. 9, 2022 and Republic of Korea Patent Application No. 10-2022-0171604, filed on Dec. 9, 2022, which are incorporated by reference herein in their entirety.

### BACKGROUND

### Technical Field

The present disclosure relates to a device and system for a communication network management and communication failure response service based on process information at a construction site, a method of providing the service, and a non-volatile recording medium in which a computer program for providing the service is recorded. In more detail, the present disclosure relates to: a device and system for a communication network management and communication failure response service based on process information at a construction site, the device and system increasing communication reliability at a construction site having various and irregular communication interference factors by finding out communication interference factors, which are generated in accordance with a work schedule at the construction site, by estimating communication elements in which a communication failure will occur due to the communication interference factors, by creating a strategy for responding to a communication failure, and making it possible to respond to the case in which it is difficult to remove a failure through only a failure response strategy based on a current communication network; a method of providing the service; and a non-volatile recording medium in which a computer program for providing the service is recorded.

### Description of the Related Art

Since various kinds of work are performed at construction sites, there are various objects that need to be checked in relation to the progress of work and there are also various dangerous factors. Accordingly, various kinds of sensors are fixedly installed or movably installed at a site in progress so that a manager can check the progress of work or can monitor generation of problems.

Further, construction equipment is also equipped with various kinds of sensors so that a manager monitors sensor measurement information to prevent problems with the equipment or accidents accompanying operation of the equipment. Further, workers are also supposed to carry a communication device equipped with sensors, whereby a manager tries to prevent the danger of accident by monitoring the location and status of the workers.

In particular, as various wireless communication technologies are developed, various kinds of environment sensors or a sensor for determining a problem with equipment, a fire sensor, a location sensor, a sensor for checking power, a sensor for checking a water level, a sensor for checking the bio-information of a worker, etc. are applied at work sites not only in a wired communication terminal type, but in an IoT terminal type that can individually connect to a communication network.

Stability of a communication network is important at construction sites where important information is transmitted using various kinds of wired and wireless communication methods, as described above, but it is difficult to construct a permanent high-quality communication network in that the communication network is used only during construction and it is also difficult to construct a stable communication network in that the communication range and characteristics are changed in accordance with progress of a construction process.

Further, it is required to expand a communication range for wireless communication shadow areas such as the underground or a tunnel while a process progresses due to the characteristic of construction sites, but it is substantially difficult to achieve stable communication due to various noise sources even though installing a repeater for wireless communication connection in a shadow area. In particular, communication quality deterioration is irregularly generated by complex factors accompanying progress of a construction process, but it is difficult to find out the exact reason of communication quality deterioration, so it is difficult to secure a stable communication network when taking measures simply on the basis of only one or two considerations.

As a result, when a communication failure is generated in the situation in which it is required to collect accident prediction or preventing information and real-time information accompanying occurrence of accidents, severe safety accidents and property damage may be generated, so new plans that can increase reliability of a communication network at construction sites are substantially acutely required.

### SUMMARY

An objective of the present disclosure is to minimize communication failures in complex situations at a construction site with various variables by analyzing influence on communication on the basis of process information and work schedule at the construction site, by estimating communication interference with communication equipment in a communication shadow area installed at the construction site, by preparing and transmitting one or more failure response strategies to shadow area communication equipment, and by changing the setting of the shadow area communication equipment in accordance with the received one or more failure response strategies when estimated communication interference is actually found out.

Further, an objective of the present disclosure is to make it possible to increase communication reliability in complex situations at a construction site by continuously training an artificial intelligence learning unit for analyzing communication influence, estimating communication interference, and creating a failure response strategy on the basis of a communication interference degree according to the progress situation of construction included in construction information or a communication interference degree according to specific work kind and position, and appropriateness information of a response strategy.

Further, an objective of the present disclosure is to enable a more active communication network management service for overcoming a communication failure by estimating generation of a failure in a construction communication network through analysis of information of physical structures and information of a work schedule included in process information at the construction site, by creating a failure response strategy of variously changing a communication setting of the construction site communication network, and adding a repeater or a power source for physically improving communication performance of a communication network and then creating again a failure response strategy when it is difficult to solve a failure through only a failure response strategy based on a current communication network.

Another objective of the present disclosure is to minimize communication failures in complex situations at a construction site with various variables by sorting a section in which a communication shadow is expected by finding out an ordinary communication state on a communication path of a construction communication network; by preparing a plurality of failure response strategies by finding out communication interference factors in a construction process of communication equipment in the communication shadow expectation section and estimating a communication interference degree; by transmitting the prepared failure response strategies to communication equipment in a section with an expected shadow after determination according to necessity of an additional communication element or an additional power, and by changing the setting of communication equipment in accordance with received one or more failure response strategies when estimated communication interference is actually found out.

Further, an objective of the present disclosure is to manage a communication network to be able to increase communication reliability in complex situations at a construction site by applying an artificial intelligence unit to a configuration that estimates communication interference factors according to the progress situation of construction included in construction process information or specific work kinds and positions, a configuration that estimate a communication interference degree of communication equipment on a communication path according to the communication interference factors, a configuration that creates a failure response strategy, and a configuration that creates application information of an additional communication element or an additional power source that can respond to a failure; and by continuously creating learning data including a relevant communication state, estimation and creation information, and actual measurement information.

In order to accomplish the above objects, the present invention provides a device for a communication failure response service based on process information at a construction site, the device comprising: a communication influence analyzer configured to select a communication failure factor in each period by receiving process information comprising physical structure information, construction equipment arrangement information, and work schedule information at the construction site; a communication path management unit configured to receive communication state information of communication elements constituting a communication network from communication equipment in the construction site, create communication path state information reflecting the communication state information to kind and arrangement information of communication equipment and communication elements prepared in advance in the construction sites, and determine a failure-expected communication path based on the communication state information; and a failure response strategy creator configured to create and transmit one or more items of failure response strategy information, which comprises a setting change parameter of the communication equipment in the construction site, to communication equipment on the failure-expected communication path in correspondence to communication interference factor information of the communication influence analyzer.

Preferably, the device for a communication failure response service based on process information at a construction site may further comprise: a communication unit configured to transmit and receive information to and from the communication equipment at the construction site, receive communication state information of communication elements comprising a repeater and a communication terminal connected to the communication equipment from the communication equipment, and receive construction site process information by communicating with a processor management server; and a communication element information management unit configured to have the kind and arrangement information of the communication equipment and the communication elements at the construction site, collect communication state information of the communication equipment and communication elements at the construction site received through the communication unit, and provide the communication state information to the communication path management unit.

Preferably, the device for a communication failure response service based on process information at a construction site may further comprise a communication interference estimator configured to learn communication state information according to arrangement positions and communication paths at the construction site of communication equipment and communication elements constituting a construction site communication network and communication interference factor information of the communication influence analyzer through the communication element information management unit and the communication path management unit, estimate communication interference degrees of communication equipment and communication elements on a communication path due to a communication interference factor, and provide a result of the estimation to the failure response strategy creator.

Preferably, the communication influence analyzer may learn communication state information of communication equipment and communication elements at each arrangement position at the construction site of the communication element information management unit, thereby estimating a communication interference element, a communication interference degree, and a communication interference period that change communication states of the communication equipment or the communication elements in the physical structure information, the construction equipment arrangement information, and the work schedule information at the construction site included in the process information.

Preferably, the failure response strategy creator may create one or more items of failure response strategy information comprising at least one item of information of setting change parameter information for setting a communication type for bypass or to be maintained and an available communication condition when a communication state becomes under a reference, setting change parameter information about change of data format to be transmitted and received, and setting change parameter information of a high-priority data type, together with communication interference estimation period information according to the process information.

Furthermore, the present invention provides a device for a communication network management service based on process information at a construction site, the device comprising: a communication influence analyzer configured to select a communication failure factor in each period by receiving process information comprising physical structure information, construction equipment arrangement information, and work schedule information at the construction site; a communication path management unit configured to receive communication state information of communication elements constituting a communication network from communication equipment in the construction site, create communication path state information reflecting the communication state information to kind and arrangement information of communication equipment and communication elements prepared in advance in the construction sites, and determine a failure-expected communication path based on the communication state information; a failure response strategy creator configured to create one or more items of failure response strategy information, which comprises a setting change parameter of communication equipment on a failure-expected communication path according to communication interference factor information of the communication influence analyzer, together with failure response possibility estimation information, and transmit failure response strategy information having a failure response possibility over a reference; and an additional-element simulator configured to create and provide simulated communication path state information, in which an additional communication element is applied to a failure-expected communication path, to the communication path management unit when the failure response strategy creator cannot create failure response strategy information having a failure response possibility over the reference.

Preferably, the communication path management unit may receive power information of power that is supplied to construction site communication equipment and communication element and applies the power information when selecting a communication interference factor in each period, and the additional-element simulator further applies an additional power source to communication equipment and a communication element on a failure-expected communication path when creating simulated communication path state information.

Furthermore, the present invention provides a system for a communication failure response service based on process information at a construction site, the system comprising: a service server configured to select a communication failure factor that will interfere with communication in each period by receiving process information comprising physical structure information, construction equipment arrangement information, and work schedule information at the construction site, create communication path state information reflected to kind and arrangement information of communication equipment and communication elements in the construction site and then determine a failure-expected communication path by receiving communication state information of the communication elements constituting a communication network from the communication equipment in the construction site, and create and transmit failure response strategy information, which comprises communication interference expectation period information according to the communication interference factor and communication equipment setting change parameter information, to communication equipment on an failure-expected communication path; and communication equipment configured to be connected with the service server through one of a plurality of communication methods, be connected to communication elements comprising a terminal and a repeater in the construction site through one of a plurality of communication methods, transmit communication state information with the service server and communication state information with communication elements to the service server, receive failure response strategy information provided from the service server, and change a communication setting thereof into a parameter of the failure response strategy information or provide communication setting change information to the communication elements when actual communication interference is found out during a communication interference expectation period.

Preferably, the communication equipment further comprises a server communication examiner configured to select and switch to one or more of a plurality of communication methods prepared in accordance with communication quality by checking communication with a service server for stable communication with the service server, and provide communication state information to the service server.

Preferably, the communication equipment further comprises: a local communication examiner configured to find out a communication state by periodically checking communication with communication elements in a communication range thereof, a local communication equipment arrangement management unit configured to store arrangement information of communication elements in a communication range thereof, a bypass communication management unit configured to change a communication setting into a parameter of failure response strategy information received from the service server; and a local communication failure section checker configured to create and provide local communication failure section information to the service server in accordance with a communication state with and arrangement positions of communication elements in the communication ranges of the local communication equipment arrangement management unit and the local communication examiner.

Furthermore, the present invention provides a system for a communication failure response service based on process information at a construction site, the system comprising: a service server configured to select a communication failure factor that will interfere with communication in each period by receiving process information comprising physical structure information, construction equipment arrangement information, and work schedule information at the construction site, create communication path state information reflected to kind and arrangement information of communication equipment and communication elements in the construction site and then determine a failure-expected communication path by receiving communication state information of the communication elements constituting a communication network from the communication equipment in the construction site, create and transmit failure response strategy information, which comprises communication interference expectation period information according to the communication interference factor and communication equipment setting change parameter information, to communication equipment on an failure-expected communication path, and dispose an additional communication element to the failure-expected communication path, or create simulated communication path state information of applying an additional power source to communication equipment on the failure-expected communication path and then create again failure response strategy information based on the simulated communication path state information when failure response strategy information over a preset level cannot be created; and communication equipment configured to be connected with the service server through one of a plurality of communication methods, be connected to communication elements comprising a terminal and a repeater in the construction site through one of a plurality of communication methods, transmit communication state information with the service server and communication state information with communication elements to the service server, receive failure response strategy information provided from the service server, and change a communication setting thereof into a parameter of the failure response strategy information or provide communication setting change information to the communication elements when actual communication interference is found out during a communication interference expectation period.

Furthermore, the present invention provides a method for a communication failure response service based on process information at a construction site, the method comprising: selecting a communication failure factor that will interfere with communication in each period by receiving process information comprising physical structure information, construction equipment arrangement information, and work schedule information at the construction site by means of a service server; determining a failure-expected communication path by receiving communication state information of communication elements constituting a communication network from communication equipment in the construction site and by creating communication path state information reflecting the communication state information to kind and arrangement information of the communication equipment and the communication elements in the construction site by means of the service server; creating and transmitting one or more items of failure response strategy information, which comprises communication interference expectation period information according to the communication interference factor and communication equipment setting change parameter information, to communication equipment on an failure-expected communication path by means of the service server; and receiving failure response strategy information from the service server, and changing a communication method by changing a setting into a parameter of the failure response strategy information by means of the communication equipment when actual communication interference is found out during a communication interference expectation period.

Furthermore, the present invention provides a method for a communication failure response service based on process information at a construction site, the method comprising: selecting a communication failure factor that will interfere with communication in each period by receiving process information comprising physical structure information, construction equipment arrangement information, and work schedule information at the construction site by means of a service server; determining a failure-expected communication path by receiving communication state information of communication elements constituting a communication network from communication equipment in the construction site and by creating communication path state information reflecting the communication state information to kind and arrangement information of the communication equipment and the communication elements in the construction site by means of the service server; creating one or more items of failure response strategy information, which comprises communication interference expectation period information according to the communication interference factor and communication equipment setting change parameter information, together with failure response possibility estimation information by means of the service server; disposing an additional communication element to a failure-expected communication path, or creating simulated communication path state information of applying an additional power source to communication equipment on the failure-expected communication path and then creating again failure response strategy information based on the simulated communication path state information when the service server cannot create failure response strategy information in the creating of failure response strategy information; transmitting failure response strategy information having a failure response possibility over a reference to communication equipment on the failure-expected communication path when the service server creates the failure response strategy information in the creating of failure response strategy information; and changing a communication method by changing a setting into a parameter of the failure response strategy information by means of communication equipment receiving the failure response strategy information when actual communication interference is found out during a communication interference expectation period.

Furthermore, the present invention provides a non-transitory computer-readable storage medium in which a computer program for operating a computer to perform a method for a communication failure response service based on process information at a construction site is recorded.

The present disclosure has an effect of improving communication quality at a construction site that is in direct relation to safety by making it possible to effectively estimate and respond communication failures that are irregularly generated in an environment in which various structures having influence on communication are constructed in accordance with a process, construction equipment having influence on wireless communication is operated, and work that causes noises such welding and installation of metal structures is frequently and randomly performed, such as a construction site.

Further, there is an effect of improving communication quality at a construction site that is in direct relation to safety by making it possible to respond a communication failure by adding an optical communication element or power source even against a communication failure that is difficult to respond using a current communication network configuration.

Further, there is an effect of being able to monitor a process and increase safety in dangerous work by solving the problem that it is difficult to solve a communication failure due to a construction site environment that influences communication even though a plurality of communication elements is configured to remove a communication failure section existing at a construction site.

Further, there is an effect of being able to increase the accuracy when finding out complex communication interference factors, estimating generation of a failure, and determining necessity of addition of communication equipment or a power source in accordance with a construction process by not only crating an appropriate failure response strategy such as selecting several bypass communication networks or changing a communication setting against a communication failure at a construction site of which the reason is difficult to analyze, but also by proposing addition of an additional communication element or power source for preventing a failure and verifying the corresponding effect.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is an exemplary diagram of a construction site in progress;

FIG. 2 is an exemplary diagram of arrangement of a construction site communication network and communication elements;

FIG. 3 is an exemplary configuration diagram of a construction site communication network according to an embodiment of the present disclosure;

FIG. 4 is a conceptual diagram of construction site communication network interference factors according to an embodiment of the present disclosure;

FIG. 5 is a configuration diagram of a service server according to an embodiment of the present disclosure;

FIG. 6 is a conceptual diagram of determining necessity of an additional communication element or an additional power source according to an embodiment of the present disclosure;

FIG. 7 is a configuration diagram of a gateway according to an embodiment of the present disclosure; and

FIG. 8 is a flowchart showing a communication network management and communication failure response process based on process information at a construction site according to an embodiment of the present disclosure.

### DETAILED DESCRIPTION

It should be noted that technological terms used in the present disclosure are used only in order to describe specific exemplary embodiments rather than limiting the present disclosure. Further, the technical terms used herein should be construed as meanings that are generally understood by those skilled in the art unless specifically defined as other meanings in the present disclosure, and should not be construed as excessively comprehensive meanings or excessively reduced meanings. Further, when the technical terms used in the present disclosure are wrong technical terms that do not exactly express the spirit of the present disclosure, they should be replaced with technical terms that can be understood right by those skilled in the art. Further, general terms used in the present disclosure should be construed on the basis of previous and following contexts in accordance with those defined in dictionaries and should not be construed as excessively reduced meanings.

Further, singular forms that are used in the present disclosure are intended to include plural forms unless the context clearly indicates otherwise. In the present disclosure, terms “configured”, “include”, or the like should not be construed as necessarily including several components or several steps described in the present disclosure, in which some of the components or steps may not be included or additional components or steps may be further included.

Further, terms including ordinals such as first and second used in the present disclosure may be used to describe components, but components should not be limited by the terms. Terms are used to only discriminate one component from another component. For example, the ‘first’ component may be named the ‘second’ component, and vice versa, without departing from the scope of the present invention.

Hereafter, exemplary embodiments of the present disclosure will be described in detail with reference to the accompanying drawings and the same or similar components are given the same reference numerals regardless of the numbers of figures and are not repeatedly described.

Further, in description of the present disclosure, detailed descriptions of well-known technologies will be omitted not to obscure the description of the present disclosure with unnecessary details. Further, it should be noted that the accompanying drawings are provided only for easy understanding of the spirit of the present disclosure and the spirit of the present disclosure should not be construed as being limited to the accompanying drawings.

Hereinafter, detailed embodiments of the present disclosure are described with reference to the drawings.

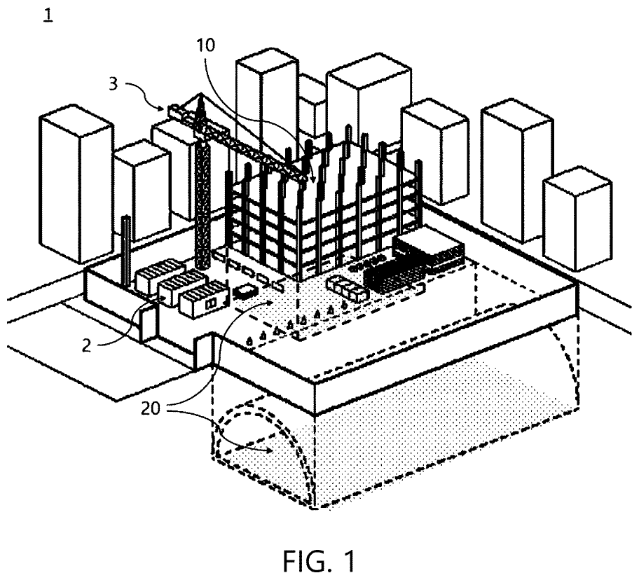

FIG. 1 is an exemplary diagram of a construction site 1 in progress, and as shown in the figure, there are buildings 10 that are construction objects, management buildings 2 for managing the construction site, and construction equipment 3. In addition, there may be temporary buildings or containers, construction materials, construction work equipment, vehicles, etc. for work.

Various kinds of wireless terminals may be disposed at the construction site 1 to monitor the progress of a construction process or prevent safety accident, and it may be possible to use a common broadband network configured already (e.g., 5G, Long Term Evolution (LTE), etc.), or use a wired/wireless communication network specifically constructed at the construction site 1 (e.g., various wire networks and a local area network and a wide area network (particularly, an unlicensed-band network)), or combine or overlap them in use. An unlicensed band is a frequency band that can be variously used for industrial, scientific, and medical (ISM) purposes and includes bands such as 902˜908 MHz (Sub-1 GHz band), 2.4˜2.4835 GHz, and 5.725˜5.850 GHz. In unlicensed-band communication technologies, communication methods such as Wireless Wide Area Network (WWAN), Wireless Local Area Network (WLAN), Wireless Personal Area Network (WPAN), and Long Range (LoRa) that transmit small-size data to various distances may be used. LoRa is a low-power wide-area (LPWA) communication network for an Internet of Thing (IoT) network and uses a frequency of 900 MHz that is an unlicensed band.

However, it is difficult to construct a permanent high-quality communication network due to the peculiarity of space and it is impossible to use only a stable wired communication method, so temporary communication networks using wireless communication methods having a predetermined area as a communication range are used.

Meanwhile, as a process progresses at a construction site, shadow areas 20 in which wireless communication is conventionally difficult such as a basement of a building and a tunnel are generated and the danger of occurrence of various safety accidents is high in such shadow areas, so it is necessary to maintain a stable communication network in shadow areas.

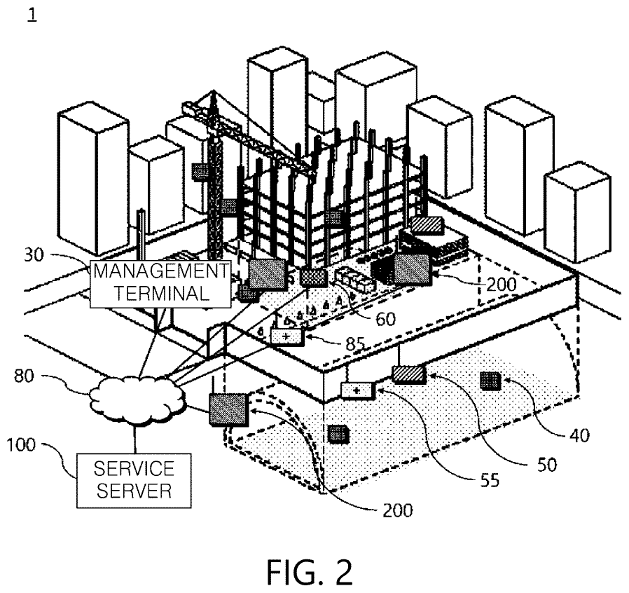

FIG. 2 is an exemplary diagram of arrangement of a construction site communication network and communication elements according to an embodiment of the present disclosure. As shown in the figures, a plurality of communication terminals 40 is disposed at a construction site 1, each communication terminal 40 is connected with a gateway 200 in a wired/wireless communication method through a repeater (or an access point) 50, and the gateway 200 is linked with a service server 100 through an external communication network 80.

The service server 100 is connected with the gateway 200 through the external communication network 80, and can receive information provided from each communication terminal 40 and transmit control information to each communication terminal 40 through the repeater 50. Further, the service server 100 can find out the progress situation of process or the occurrence situation of problem by receiving, analyzing, and managing the information provided from each communication terminal 40.

The service server 100 is linked with a management terminal 30 through the external communication network 80 so that managers can connect to the service server 100 and monitor generation of problems. Of course, the management terminal 30 may transmit and receive information to and from the communication terminal 40 by directly communicating with the gateway 200 at the construction site.

The external communication network 80 includes wired/wireless communication networks and may be the internet, Local Area Network (LAN), Wide Area Network (WAN), Private Network/Virtual Private Network (PN/VPN), a wireless communication network (5G, LTE), LoRa network, etc.

The communication terminal 40 according to an embodiment of the present disclosure includes one or more Internet of Things (IoT) modules that are configured in a fixed type or a movable type at the construction site and collect and provide various items of information to the service server 100 or the management terminal 30. The IoT module may include a sensing configuration for information collection, a communication configuration for communication, an information management configuration that accumulates, manages, or analyzes information, and a control configuration that performs determination on conditions and may further include an output configuration that provides information to the outside (outputs a sound or a voice, displays visual information, interfaces with an external device) or provides physical status variation (temperature variation, humidify variation, provision of physical force, provision of electrical output, etc.).

For example, the communication terminal 40 may include sensing devices such as a noise sensor, a particulate matter sensor, a meteorogical observation (wind direction, wind velocity, precipitation, atmospheric pressure, temperature/humidity) sensor, an odor (hydrogen sulfide, ammonia) sensor, an approach sensor that is mounted on or attached to equipment and senses movement or approach, a gas sensor that senses the concentration of Co2, Co, H2S, etc., a pressure sensor that senses the pressure of gas or liquid, an acceleration sensor that senses a slope or vibration and shock, an action sensor that detects movement, motions, light, a distance, opening/closing, etc., an ultrasonic sensor that detects vibration and a distance, a humidity sensor that senses submersion, leakage of water, humidity, etc., an electrical sensor that measures voltage, current, and power, and a fire sensor that measures factors such as flame/smoke/gas/heat. Further, the communication terminal 40 can transmit sensing information collected through a communication device to the service server 100.

Further, the communication terminal 40, if necessary, may accumulate and store collected sensing information or remove noises, or selectively provide necessary information to the service server 100 while managing information such as outputting only abnormal information.

Further, the communication terminal 40 can determine occurrence of an event in accordance with collected sensing information and a control reference received from the service server 100 and can generate a control signal corresponding to occurrence of the event. When an output device is included, the communication terminal 40 can output a sound or a voice in accordance with a corresponding control signal, display visual information, operate a ventilator to take corresponding measures, or transmit an electrical signal to various actuators.

Accordingly, the communication terminal 40 is installed at several places in the construction site 1 and not only plays a necessary role in determination of a progress situation of process, but performs a necessary function to prevent and settle many safety accidents. Meanwhile, such a communication terminal 40 may be configured in an IoT module type, may be configured as a combination of a plurality of IoT modules, or may be configured as a sensing information communication transmission configuration without a controller rather than IoT.

Further, the communication terminal 40 can support one or more communication methods and can change communication methods in accordance with external control or self determination, which includes change of a communication type itself or change of communication setting.

As a local communication network for the construction site 1, the communication terminals 40 are connected with communication equipment (the gateway 200 in an embodiment of the present disclosure) in a wired/wireless communication method through the repeater (or an access point) 50.

An access point performs various functions such as functioning as a bridge for connecting wireless and wired communication, relaying connection of a network, and sharing a connection channel. An access point performs a function of receiving a signal of a common wireless communication method through a set communication method and transmitting the signal to a repeater, a gateway, a router, or the like.

A repeater is a device that receives, amplifies, and transmits back a signal, and performs a function of receiving signals of various physical communication methods and transmitting the signals through various physical communication methods. For example, a repeater may receive a first wireless signal and relay the first wireless signal as a second wireless signal and may receive a wireless signal and relay the wireless signal as a wired signal.

Recently, as the function of a repeater or the function of a network gear is included in an access point, or the function of an access point is included in the function of a repeater, the boundary becomes uncertain, so the repeater according to an embodiment of the present disclosure may be understood as including all kinds of communication network components that connect a communication terminal and communication equipment (gateway) including an access point.

Communication equipment is a general term that means several pieces of equipment constituting a communication network, and a communication terminal or an access point, a gateway including a repeater, a router, etc. may be included. However, in description of embodiments of the present disclosure, communication equipment that is a device directly communicating with the service server 100 is described by exemplifying the gateway 200, and a plurality of repeaters (or access points) 50 and the communication terminal 40 that are linked with the gateway 200 are referred to as communication elements.

Subscriber network-related communication devices, such as a plurality of repeaters 50, an access point, a network gear, a switch, and a router, and communication devices 40 linked with the communication devices can be combined in various ways, if necessary, when a communication network is configured, so all of communication-related devices linked to a communication network configured at a construction site may be generally referred to communication elements, only communication elements directly connected with the service server 100 are specifically referred to as (server-connected) communication equipment, and a gateway is exemplified as communication equipment in the description of an embodiment of the present disclosure. That is, a gateway is exemplified as communication equipment for a wide area network directly connected with the service server 100 and communication equipment for a local network configured as a lower network of the gateway is classified as a communication element.

Further, the construction site communication network described through embodiments of the present disclosure may include Wireless LAN (WLAN), Digital Living Network Alliance (DLNA), Wireless Broadband (Wibro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), a 5G mobile communication service, Bluetooth, Long Range (LoRa), Radio Frequency Identification (RFID), Infrared Data Association (IrDA), Ultra Wideband (UWB), ZigBee, Near Field Communication (NFC), Ultra Sound Communication (USC), Visible Light Communication (VLC), Wi-Fi, Wi-Fi Direct, etc.

In such construction site communication network, the communication performance between the communication terminal 40 and the repeater may change, depending on the progress of process, the details of construction, and the schedule, the communication terminal 40 and the repeater 50 can respond to a communication failure by changing the settings by supporting a plurality of communication methods or communication settings, but it is impossible to respond to a communication failure in some cases by simply changing a communication setting due to a physical limitation. In this case, it is required to physically further configure an additional repeater 55.

For the same reason, a communication failure may be generated on the path through which the gateway 200, which is communication equipment, is connected with the external communication network 80 to connect to the service server 100, and when it is impossible to solve the communication failure by switching to a pre-configured bypass network or changing a communication setting, it is required to further configure an additional repeater 85.

It is possible to reduce the possibility of generation of a communication failure through excessive configuration of a repeater relatively to a necessary communication band or stability, but it is not easy to install and manage a repeater due to the characteristics of construction sites, so it is required to install a repeater of an appropriate level. It is preferable to install additional repeaters 55 and 85 as assistant only when it is determined that it is impossible to overcome a problem even through several communication setting change strategies in consideration of a communication interference level, as described above, but there is a problem that it is not easy to determine installation of an additional repeater for maintaining a communication network.

According to the present disclosure, it is proposed to install the additional repeaters 55 and 85 when the possibility of overcoming a communication failure is low by estimating a communication failure due to various communication interference factors, creating several failure response strategies based on communication setting change, and then checking the possibility of overcoming the communication failure through the corresponding failure response strategies, and it is possible to propose installation of an optimal additional repeater by simulating communication elements, a communication path, and a communication state accompanying installation of the additional repeaters 55 and 85 and then checking a failure response possibility for a simulated communication network.

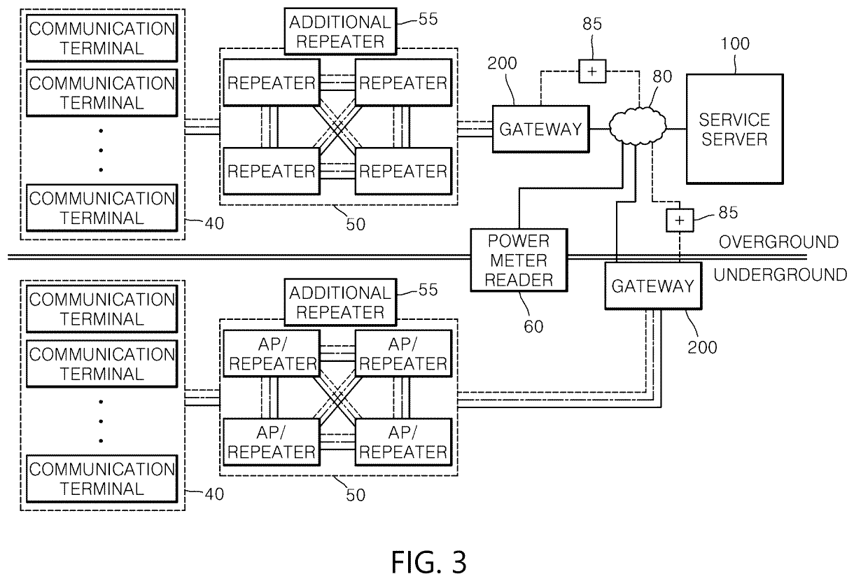

FIG. 3 is an exemplary configuration diagram of a construction site communication network according to an embodiment of the present disclosure. As shown in the figure, the communication network includes a plurality of communication terminals 40 configured in a ground area, a repeater 50 composed of a plurality of communication relay-related communication elements that is in charge of communication connection between the plurality of communication terminals 40 and a gateway 200, and the gateway 200 receiving information provided from the communication terminals 40, transmitting the information to a service server 100, and providing control information provided from the service server 100 to the communication terminals 40.

Meanwhile, a communication network for an underground shadow area in which a communication shadow may be easily generated also has the same configuration.

The gateway 200 according to an embodiment of the present disclosure performs conventional gateway functions such as a function of transmitting a signal of the communication terminal 40, which connects to the repeater 50 in various kinds of physical wireless communication methods, in accordance with a format, a communication cycle, a priority, etc. set for the service server 100 and a function of receiving various items of control information provided from the service server 100 and providing the control information in accordance with a format, a communication cycle, a priority, etc. corresponding to each communication terminal 40.

Further, the gateway 200 according to an embodiment of the present disclosure is configured to be able to respond to a communication failure due to various communication interference factors even though it is at a position where a communication failure is expected by being linked with the service server 100.

The service server 100 according to an embodiment of the present disclosure estimates a communication failure period, a failure-expected communication path, and the degree of interference with communication by analyzing detailed construction process information that may cause a communication failure such as physical structure information, construction equipment arrangement information, and work schedule information at a construction site, and creates and provides various items of failure response strategy information (including parameter information for communication setting change and communication interference estimation period information) for overcoming a failure due to the communication interference to the gateway 200.

The gateway 200 according to an embodiment of the present disclosure provides communication state information (communication quality information such as the number of time of retrying communication, a noise-to-signal ratio, and communication connection suspension) of communication elements including the repeater 50 and the communication terminal 40, which are linked, to the service server 100, receives failure response strategy information, and recovers a communication failure while changing a communication setting in accordance with the received failure response strategy information when substantial communication interference (communication quality deterioration) is determined in the communication interference estimation period.

Such communication setting change includes setting change parameter information of various pieces of communication equipment that switches to another wireless communication method of physical wireless communication methods, which can be simultaneously used, or changes a communication band, a transmission amount, a priority, an error information level, etc. Such communication setting change may be fundamentally for overcoming a communication failure with the service server 100 by changing the setting of the gateway 200, may be for overcoming a communication failure with the repeater by changing the setting of the gateway 200, may be for overcoming a communication failure between the repeater 50 and the communication terminal 40 by transmitting setting change information about the repeater 50 and the communication terminal 40.

Meanwhile, it may be impossible to overcome a communication failure only through such communication setting change, and it may be impossible to implement stable transmission and reception through only the configuration of a current communication network in the environment of a construction site in which an increase of physical structures accompanying progress of a construction process, an increase of various communication interference structures, work by construction equipment, progress of work that influences communication, etc. complexly act.

For this problem, it may be possible to further configure an additional repeater 55 on a path with a poor communication state in a repeater configuration that performs relaying between the gateway 200 and the communication terminal 40, if necessary, as shown in figures, and it may be possible to further configure an additional repeater 85 on the communication path of the gateway 200 and the external communication network 80.

Meanwhile, power sources of the gateway 200 and the repeater 500 may become unstable during progress of a process due to the peculiarity that it is a construction site using limited resources, in addition to change or addition of a communication range or a communication method, which may cause a fatal communication failure. For example, when a power source for welding that irregularly causes flow of a large amount of current shares a power source of the gateway 200 or the repeater 50, a communication failure may be generated by rapid shock of a power source.

Accordingly, in an embodiment of the present disclosure, the service server 100 receives and compares power states of respective power sources, which are read by a power meter reader 60 shown in figures, with a process schedule, thereby being able to determine power source instability accompanying a specific process and to determine which communication equipment or communication element has a communication failure on the basis of communication state information at a corresponding point in time.

In this case, it is possible to specifically separate the power source of a repeater 50 or a gateway 200 having a communication failure due to power source instability or to further apply a battery (not shown) to the power source of corresponding communication equipment or communication element in accordance with a specific process schedule.

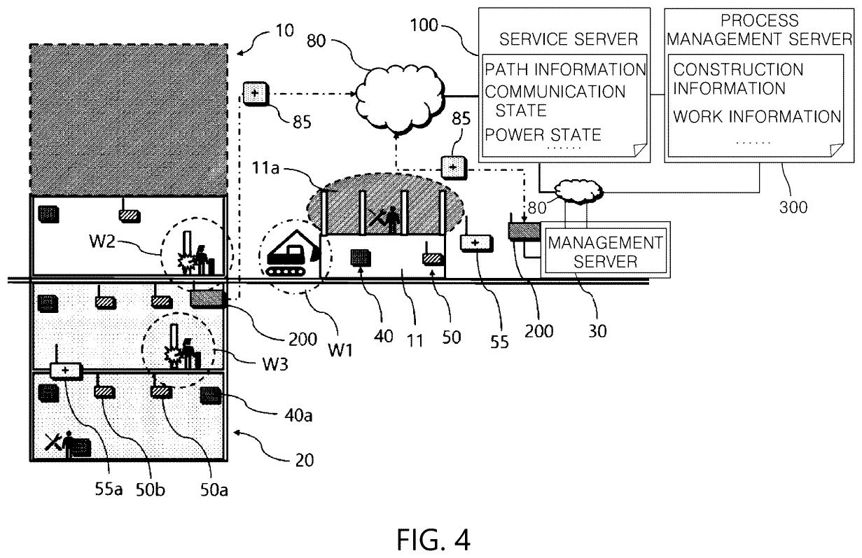

A communication network management service based on process information at a construction site according to an embodiment of the present disclosure is described with reference to FIG. 4 to FIG. 7.

FIG. 4 is a conceptual diagram of construction site communication network interference factors according to an embodiment of the present disclosure. As shown in the figure, pluralities of repeaters 50 and communication terminals 40 are configured in an expected basement shadow area 20 of a building 10 that is being constructed at a construction site, and they are connected with a service server 100 through a gateway 200. The gateway 200 is connected with the service server 100 in a wired or wireless communication method through an external communication network 80 and they may be connected with the service server 100 through the external communication network 80 through the gateway 200 using a bypass network.

The communication method of the service server 100 and the gateway 200 may use communication methods such as Wireless LAN (WLAN), Digital Living Network Alliance (DLNA), Wireless Broadband (Wibro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), a 5G mobile communication service, Bluetooth, Long Range (LoRa), Radio Frequency Identification (RFID), Infrared Data Association (IrDA), Ultra Wideband (UWB), ZigBee, Near Field Communication (NFC), Ultra Sound Communication (USC), Visible Light Communication (VLC), Wi-Fi, Wi-Fi Direct, etc.

As shown in the figures, the physical shapes of buildings 10 and 11 at the construction site change and several communication interference factors may be generated in the construction process of the buildings 10 and 11. For example, a physical increase in volume may interfere with communication, communication may be interfered with by work W1 of construction equipment that is a large metal structure, and communication may be interfered with by several metal structures and walls formed in the building 11. Further, several kinds of work W2 and W3 on the communication path between a communication shadow area and a ground communication section may interfere with communication. Communication noises may be rapidly increased by work that distorts an electric field on a communication path by generating strong electrical shock and plasma such as a welding process exemplified in the figures, and communication may become unstable by power variation of the repeater 50 or the gateway 200 due to electric welding that uses a large amount of power.

For example, when there is a electric communication terminal 40a including a gas sensor on a second basement level, gas concentration information measured by the communication terminal 40a can be transmitted to the gateway 200 on the first basement level through repeaters 50a and 50b and provided to the service server 100. Such a service server 100 can find out that connection of the communication terminal 40a is poor in the corresponding basement section from communication state information provided from the gateway 200 and can set the section or the corresponding communication path as a failure-expected communication path. Thereafter, the service server 100 finds out information about communication interference factors in the failure-expected communication path from process information or work schedule information related to various construction processes received from a process management server 300.

For example, as shown in the figure, when gas concentration information provided from the communication terminal 40a is transmitted through the gateway 200 through the plurality of repeaters 50, welding W3 is in progress on the communication path of communication elements, such as the communication terminal 40a and the repeaters 50a and 50b, and a shadow gateway 200 with the gateway 200 and the external communication network 80 connected by a wireless signal, and welding W2 and construction equipment work W1 are in progress on the path for connection of the gateway 200 and the external communication network 80, the gas concentration information that is provided to the service server 100 from the gateway 200 may not be normally transmitted by the influence of one or more of the work.

When the gas concentration information is information that is in close connection with safety of workers, such failure in the communication network can cause fatal accidents.

In particular, as exemplified, it is difficult to accurately find out what reasons cause a communication failure in an environment in which many factors, such as process work, arrangement of process equipment, and progress of work and a building process, complexly act, so it is difficult to effectively remove a communication shadow only by simply selecting bypass communication.

Accordingly, the service server 100 according to an embodiment of the present disclosure determines a failure-expected communication path by receiving the communication state between communication equipment and the service server 100 through the gateway 200 that is construction site communication equipment directly communicating with it and communication state information of communication elements (the repeater 50 and the communication terminal 40) managed by the gateway 200, derives communication interference factors by receiving information about various process states, details of work, and a schedule that are related to a construction process and by analyzing the communication state information and communication influence accompanying the schedule, estimates the degree of interference with communication that influences the failure-expected communication path by the communication interference factors, and then creates a failure response strategy of changing the communication settings of the communication equipment or the communication elements to respond to the failure.

When it is determined that it is difficult to respond to a communication failure through a failure response strategy of changing communication settings, it is possible to add additional communication elements (repeaters) 55a and 85 on the failure-expected communication path, simulate the communication state on the communication path when the communication elements are added, check again the failure-expected communication path on the basis of the simulation, and estimate again communication interference information, and create again a failure response strategy including communication setting change.

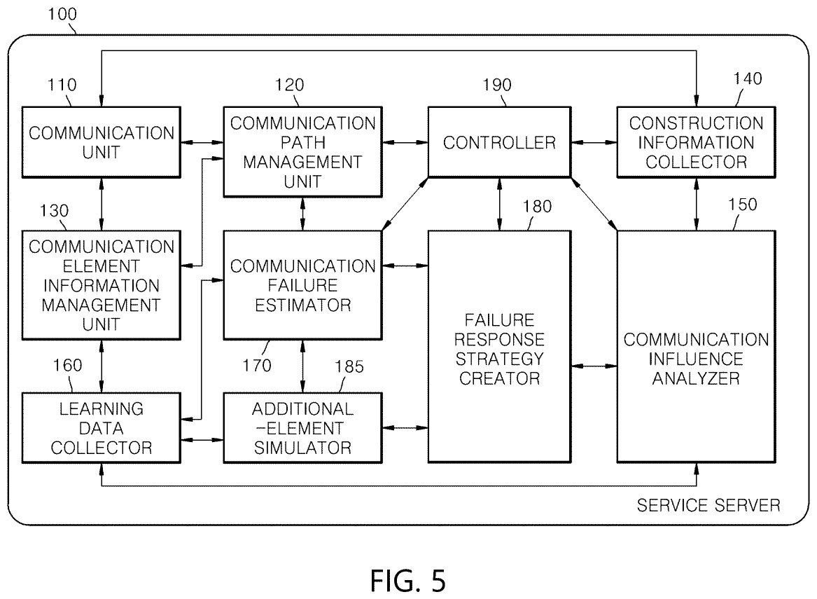

FIG. 5 is a configuration diagram of the service server 100 according to an embodiment of the present disclosure. As shown in the figure, the service server includes: a communication unit 110 that transmits and receives information to and from communication equipment (a gateway 200 in an embodiment of the present disclosure), receives communication state information thereof and communication state information of communication elements including a repeater 50 and a communication terminal 40 connected with the communication equipment from the communication equipment (e.g., a gateway), and receives construction site process information by communicating with a process management server 300; a communication element state management unit 130 that has kind and arrangement information of the communication equipment 200 and the communication elements 40 and 50 at the construction site and collects the communication state information of the communication equipment 200 and the communication elements 40 and 50 at the construction site; a communication path management unit 120 that creates communication path state information reflecting the communication state information in the kind and arrangement information of the communication equipment 200 and the communication elements 40 and 50 at the construction site in linkage with the communication element state management unit 130, and determines a failure-expected communication path on the basis of the communication path state information; a construction information collector 140 that receives process information, which includes physical structure information, construction equipment arrangement information, and work schedule information, through the communication unit 110; a communication influence analyzer 150 that selects a communication failure factor in each period from the process information collected by the construction information collector 140; a communication failure estimator 170 that estimates the degree of interference with communication of communication equipment and communication elements on a communication path by communication interference factors by learning the arrangement positions of the communication equipment 200 and the communication elements 40 and 50, which constitute a construction site communication network, at the construction site, communication state information according to the communication path, and communication interference factor information of the communication influence analyzer 150 through the communication element information management unit 130 and the communication path management unit 120; a failure response strategy creator 180 that creates one or more items of failure response strategy information, which includes setting change parameters of communication equipment on the failure-expected communication path, together with failure response possibility estimation information on the basis of the communication interference factor information of the communication influence analyzer 150 and the degree of interference with communication of the communication equipment and communication elements on the failure-expected communication path of the communication interference estimator 170, and transmits failure response strategy information having a failure response possibility over a reference to the communication equipment 200 on the failure-expected communication path; an additional-element simulator 185 that creates simulated communication path state information by adding an additional communication element to the failure-expected communication path when the failure response strategy creator 180 cannot create a failure response strategy information having a failure response possibility over the reference, and provides the simulated communication path state information to the communication path management unit 120.

Further, the service server 100 includes a controller 190 that manages detection of communication interference factors through the construction information collector 140 and the communication influence analyzer 150 and corresponding operation of the communication interference estimator 170 and the failure response strategy creator 180, operates again the communication interference estimator 170 and the failure response strategy creator 180 to create a failure response strategy for a new failure-expected communication path and against communication interference factors on the basis of the new failure-expected communication path when the communication path management unit 120 receiving the simulated communication path state information obtained by operation of the additional-element simulator 185 provides the new failure-expected communication path, and determines whether failure response is successful by collecting the created communication interference factors and corresponding failure response strategy information, simulated communication path state information and corresponding failure response strategy information when an additional element is applied, and communication state information after performance of a failure response strategy.

The communication interference estimator 170 includes a learning unit that learns the degree of interference with communication of the communication equipment 200 and the communication elements 50 and 40 by interference factors at each arrangement position at the construction site by learning communication interference factor information, and an estimator that estimates the degree of interference with communication on the basis of the details learned through the learning unit.

The service server 100 may further includes a learning data collector 160 that collects, as learning data, failure-expected communication path information of the communication path management unit 120, information about the kinds, arrangement positions, a communication method to be used, etc. of corresponding communication equipment and communication elements, information about communication interference factors and interference period provided from the communication influence analyzer 150, and communication state information of the communication equipment and the communication elements for the interference period collected through the communication element information management unit 130 for learning of the communication interference estimator 170, and provides the learning data to train the learning unit of the communication interference estimator 170. The learning data may include communication interference factors and corresponding failure response strategy information, simulated communication path state information and corresponding failure response strategy information when an additional element is applied, and communication state information after performance of a failure response strategy that are collected by the controller 190.

Meanwhile, the communication influence analyzer 150 may also includes: a learning unit that learns communication interference factors, the degree of interference with communication, and a communication interference period, which change the communication states of communication equipment or communication elements in physical structure information, arrangement information of construction equipment, an work schedule information included in process information by learning communication state information of the communication equipment and the communication elements at each arrangement position at the construction site of the communication element information management unit 130 and process information of the construction information collector 140; and an estimator that estimate communication interference factors, the degree of interference with communication, and a communication interference period on the basis of the learning.

The failure response strategy creator 180 can create one or more items of failure response strategy information including at least one item of information of setting change parameter information for setting a communication type for bypass or to be maintained and an available communication condition when a communication state becomes under a reference, setting change parameter information about change of data format to be transmitted and received, and setting change parameter information of a high-priority data type, together with communication interference estimation period information according to process information.

The failure response strategy information may be determined in accordance with pre-prepared communication bypass method or communication setting method rules. For example, when a failure of a specific communication method is estimated, it may be created in accordance with pre-prepared rules such as selecting another communication method having penetration power higher than the communication method, decreasing a bandwidth, increasing the size of recovery data for data recovery, or changing a transmission/reception cycle, and accordingly, a failure response possibility may be calculated in accordance with a pre-prepared failure response possibility calculation equation.

Meanwhile, the failure response strategy creator 180 may include a reinforcement learning unit or a deep reinforcement learning unit that creates communication setting change parameter information for communication equipment or communication elements on the basis of the communication interference factors, the degree of interference with communication, and the communication interference period estimated by the communication influence analyzer 150, the degree of interference with communication of communication equipment, communication elements, and a communication path at each arrangement position in the construction site by the interference factors estimated by the communication interference estimator 170, and information about whether a failure response is successful provided by the controller 190. The (deep) reinforcement learning unit can be trained in the manner of changing (acting) the communication setting change parameter information for shadow-estimated communication equipment and communication elements on the basis of the communication interference factors, the degree of interference with communication, the communication interference period, and the current communication state (environmental information and the current state) for the purpose of success (reward) of failure response.

Further, the failure response strategy creator 180 can estimate failure response possibility estimation information depending on application of the created failure response strategy information through the learning unit and the estimator.

The communication influence analyzer 150 can efficiently respond to complex and irregular communication failures at the construction site through an artificial intelligence estimation configuration of the communication interference estimator 170 and the failure response strategy creator 180. In particular, it becomes possible to gradually precisely respond to a communication failure through continuous repetitive learning, updating of the details of learning, sharing of learning information of several similar construction sites, etc. due to the characteristics of artificial intelligence.

Meanwhile, when failure response strategy information in which the failure response possibility of a failure response strategy created by the failure response strategy creator 180 is over a reference is not created, that is, when it is impossible to respond to a failure through communication setting change, the additional-element simulator 185 adds additional communication elements (repeaters 55 and 85) to a failure-expected communication path and creates new simulated communication path state information added with the additional communication elements. Such simulated communication path state information, in relation to the added communication elements, information, may include an arrangement position, path information, information of a simulated communication state with adjacent communication equipment or elements in the path information. This makes it estimate the communication states of communication equipment and communication elements on a communication path in a specific communication state or the communication state of communication equipment, communication elements, and a new communication element when the new communication elements is applied, by accumulatively learning the communication state information of the communication equipment and communication elements on the communication path in the specific communication state and communication state information when a new communication element is added to the communication states between communication elements.

When new simulated communication path state information is created, as described above, the communication path management unit 120 finds out again a failure-expected communication path, the communication failure estimator 170 computes again communication interference by communication interference factors when a failure-expected communication path exists, and the failure response strategy creator 180 creates a failure response strategy on the basis of the communication interference factors and new failure-expected communication path information when it is expected that communication interference exists.

When the created failure response strategy is not satisfactory even in this case, a process of further apply a new communication element by means of the additional-element simulator 185 may be repeated.

Meanwhile, the communication influence analyzer 150 can receive power information of a power source that is supplied to communication equipment 200 and communication elements 40 and 50 at the construction site and apply the power information when selecting communication interference factors in each period.

In this case, the additional-element simulator 185 can further apply a additional power source to the communication equipment 200 and communication elements 40 and 50 on a failure-expected communication path when creating simulated communication path state information.

The communication unit 110 briefly described above can support at least some of various wireless communication methods such as Wireless LAN (WLAN), Digital Living Network Alliance (DLNA), Wireless Broadband (Wibro), World Interoperability for Microwave Access (Wimax), Global System for Mobile communication (GSM), Code Division Multi Access (CDMA), Code Division Multi Access 2000 (CDMA2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), a 5G mobile communication service, Bluetooth, Long Range (LoRa), Radio Frequency Identification (RFID), Infrared Data Association (IrDA), Ultra Wideband (UWB), ZigBee, Near Field Communication (NFC), Ultra Sound Communication (USC), Visible Light Communication (VLC), Wi-Fi, Wi-Fi Direct, etc., and can support some of various wired communication methods such as Ethernet, optical communication, coaxial cable communication, and power line communication, etc.

The communication unit 110 receives collection information of the communication terminal 40 and various items of control information by setting a direct/indirect communication channel with the gateway 200 that is communication equipment at the construction site. Further, the communication unit 110 collects process information about construction from the process management server 300.

The process management server 300 collects and manages information about a process progress situation, a work schedule, and the details of work at the construction site 1. The process management server 300 manages also information about physical structures accompanying progress steps of building in the space of the construction site, information about the processes that are applied to building as processes progress (application of steel-frame structures, forming of walls, application of concrete, etc.), information about the kinds of processes and required construction equipment, and information about detailed details of work and a schedule.

For example, it is possible to provide information about where buildings having what heights currently exist with what processes progressed and information about what has changed in comparison to before, it is possible to know what construction equipment (an excavator, a large truck, a crane, etc.) is disposed at what positions and will perform what work, and it is possible to know where and how long specific work (welding, construction of walls, plastering, woodworking, painting, etc.) will be performed.

Accordingly, process information, which includes physical structure information, construction equipment arrangement information, and work schedule information at the construction site, is received and stored from the process management server 300 through the construction collector 140 and the communication unit 110 of the service server 100, and information about new physical structure variation, construction equipment arrangement, and work that have changed in comparison to before are selected and provided to the communication influence analyzer 150.

Meanwhile, the communication unit 110 provides the received communication state information of the communication equipment and the communication elements at the construction site to the communication element state management unit 130 and the communication element state management unit 130 has the kind and arrangement information of the communication equipment 200 and the communication elements 40 and 50 in the construction site in advance and matches and accumulates the communication state information of the communication equipment and the communication elements. The arrangement positions of communication equipment and communication elements may be section information, coordinate information, etc. corresponding to the position information in the construction site and may be registered or updated when the communication equipment and the communication elements are installed or changed.

The communication path management unit 120 can create communication path state information by reflecting the communication state information of the communication equipment and the communication elements collected through the communication element state management unit 130 to the kind and arrangement information of the communication equipment and the communication elements in the construction site, can sort communication equipment and communication elements with a communication failure or at least communication quality deterioration and the communication path thereof, and can classify the path between communication equipment and communication elements in which a communication failure is frequently generated as a failure-expected communication path in accordance with the frequency or the degree of the communication failure.

Information of positions at which communication equipment and communication elements are installed may include the physical information or the class of the positions and may include also classes considering the positional characteristics of a first basement level, a second basement level, an underground tunnel, an underground machine room, etc. Of course, even though such a positional characteristic is a path on which a communication shadow is generally frequently generated, when the actually collected communication state information of communication equipment or communication elements is good, the path may not be determined as a failure-expected communication path, and even though a physical position is the ground, the path may be determined as a failure-expected communication path when the case in which the communication state information of communication equipment or communication elements is lower than a reference is frequently generated. Further, for a section in which important information needs to be collected, the path may be determined as a failure-expected (prevented) communication path regardless of the actual communication state.

Such failure-expected communication paths are selected to select a path having a history of deterioration of a communication state accompanying progress of a construction process on the basis of accumulate communication states and to accurately find out interactions of the path and interference factors accompanying a construction process. It is possible to create an optimal response strategy for responding to a failure by accumulating actual communication quality deterioration information of communication equipment or communication elements on a failure-expected communication path due to such interference factors.

The communication influence analyzer 150 analyzes (estimates on the basis of artificial intelligence as a preferred embodiment) communication interference factors, the degree of interference with communication, and a communication interference period that change the communication states of communication equipment or communication elements in physical structure information, construction equipment arrangement information, and work schedule information at a construction site included in process information, and determines communication interference factors when a physical structure on a communication path of physical structures at the construction site meaningfully changes (a steel-frame structure is installed, a wall is installed, the number of floors is increased, etc.) with progress of a process and when new information is found out in the arrangement, the details of work, and the work period schedule of construction equipment (an excavator, a large truck, a crane, etc.) in a construction process, the details of various construction work (welding, construction of a wall, plastering, woodworking, painting, etc.), and a work period schedule.

For example, when the number of floors of a building on a communication path increases, when a new steel-frame is installed, when construction equipment is disposed and performs work on a communication path, when welding is performed on a communication path, etc., these cases are determined as communication interference factors, and the period for which such work progresses or an overlap work period for which complex communication interference factors are complexly combined and progressed may be determined as a communication interference period.

Further, as described above, when learning information of actual communication quality deterioration of communication equipment or communication elements for the work period of communication interference factors through the estimator, the communication influence analyzer 150 may estimate communication interference factors that can cause communication quality deterioration of communication equipment or communication elements on a failure-expected communication path selected through the estimator on the basis of the information.

When the communication influence analyzer 150 estimates or analyzes and provides communication interference factors and a communication interference period, the communication failure estimator 170 can provide communication interference factors currently estimated through the estimator based on the details of learning the degree of interference with communication of the communication equipment 200 and the communication elements 50 and 40 at each arrangement position at the construction site due to communication interference factors and communication interference information of the communication equipment 200 and the communication elements 50 and 40 on a failure-expected communication path for a communication interference period, that is, the detailed result of estimating the degree of communication quality deterioration when what communication method is used, the degree of communication quality deterioration when what communication setting is used, etc. For example, estimation is possible in manners in which when the gateway 200 maintains communication with the service server 100 through a Wi-Fi 2.5 Ghz communication method, communication quality deterioration of a specific range is expected for a specific interference period, or when the repeater 50 and the communication terminal 40 communicate with each other in a Bluetooth 4.0 communication method, impossible data transmission is expected for a communication interference period, etc.

The failure response strategy creator 180 creates and provides the gateway 200 with a plurality of items of failure response strategy information including at least one item of information of setting change parameter information for setting a communication type for bypass or to be maintained and an available communication condition when a communication state becomes under a reference, setting change parameter information about change of data format to be transmitted and received, and setting change parameter information of a prior data type, in accordance with priority, together with information of a communication interference period.

The gateway 200 can repeat a process of finding out a communication path in which actual communication performance decreases fro a communication interference estimation period, changing the communication setting of a communication element related to the path or thereof into a setting parameter included in a failure response strategy information, checking corresponding communication performance, and maintaining the setting parameter when the communication performance is over a reference, and changing the setting parameter into a setting parameter of a subordinate failure response strategy information when the communication performance is under the reference. Thereafter, when communication performance over the reference is maintained and a communication failure is overcome or when communication performance is not maintained for a communication interference estimation period and the communication performance is recovered after the communication interference estimation period, it is possible to transmit communication performance information according to a failure response strategy to the service server 100, and the controller 190 of the service server 100 can provide communication state information according to the failure response strategy to the learning data collector 160 and can update the learning information of the estimator included in at least one of the communication failure estimator 170, the communication influence analyzer 150, and the failure response strategy creator 180.

When it is difficult to overcome a failure using only failure response strategy information with a current communication network maintained, the additional-element simulator 185 creates a modified communication network in which an additional communication element is applied to a failure-expected communication path or an specific additional power source is provided to communication equipment (gateway) or a communication element (repeater) on the failure-expected communication path, and creates corresponding simulated communication path state information. The controller 190 can obtain information of application of an additional communication element or an additional power source and notify a manger of the information, can notify a manager of information about an additional communication element or an additional power source as proposal information for updating a communication network after checking whether a communication failure can be solved through a failure response strategy information of the failure response strategy creator 180 when the communication failure is not generated in accordance with simulated communication path state information depending on additional-element simulation or even though the communication failure is generated, and receives the result of adding a communication element of a power source in accordance with such a proposal and then creates and transmits failure response strategy information to communication equipment using communication path state information simulated on the basis of the changed communication network configuration.

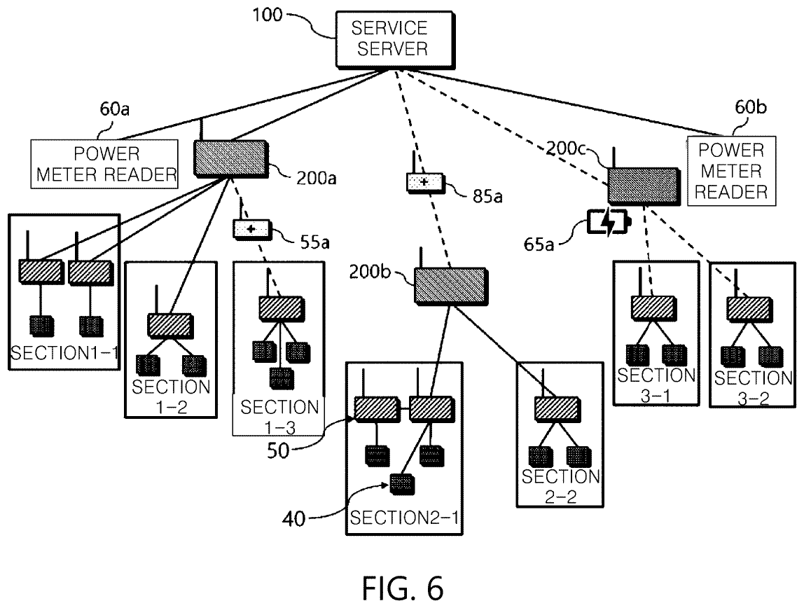

FIG. 6 is a conceptual diagram of determining necessity of an additional communication element or an additional power source according to an embodiment of the present disclosure. As shown in the figures, communication equipment and communication elements constituting a construction communication network, and communication paths including physical arrangement of the communication equipment and communication elements are shown. The communication paths include a communication path with communication equipment (gateway) 200 communicating with the service server 100, communication paths between pieces of communication equipments 200a to 200c and repeaters 50, and communication paths between the repeaters 50 and communication terminal 40. When communication state information of communication path or communication elements is reflected to a corresponding communication path, it is possible to create communication path state information that can discriminate a stable communication path and a communication path with an unstable accumulated communication state.

The communication path management unit 120 can create communication path state information by communication state information provided from the communication element state management unit 130 and can select a failure-expected communication path by classifying communication state information of communication equipment or communication elements accumulated and collected in an existing communication situation (accumulated in a specific period communication state, accumulated for a high weight in a recent communication state, accumulated only when a failure is generated, etc.), as indicated by dotted lines, in accordance with a reference.

Such failure-expected communication paths are obtained by sorting communication paths having a history in which they were influenced by various environments around construction sites. When a communication interference possibility due to communication interference factors according to the communication influence analyzer 150 is computed for all of communication equipment and communication elements in a construction site communication network, system efficiency decreases, so such failure-expected communication paths are for limiting the objects of communication interference estimation to configure a efficient and realistic system. Reference for selecting such failure-expected communication paths may be determined in various ways in accordance with invested resources or required communication quality.

In the example shown in the figure, a first gateway 200a is connected with communication terminals 40a existing in three sections through one or more repeaters 50 configured for each section, and constitutes corresponding communication paths. A second gateway 200b constitutes communication paths with repeaters 50 and communication terminals 40 existing in two sections and a third gateway 200c also constitutes communication paths with repeaters 50 and communication terminals 40 existing in two sections.

Meanwhile, the communication path management unit 120 of the service server 100 receives the power state information of a power source connected with communication equipment or communication elements from the power meter reader 60, that is, receives meter-reading results (a power consumption amount and a measurement time) of power meter readers 60a and 60b for a plurality of different independent power sources. The communication path management unit 120 may have power source connection information of communication equipment and communication elements corresponding to each of power meter readers 60a and 60b.

In the example shown in the figure, it is possible to know that the accumulated communication state between the first gateway 200a and the repeaters in the section 1-3 corresponds to a failure-expected communication path reference (indicated by a dotted line), the accumulated communication state between the second gateway 200b and the service server 100 corresponds to a failure-expected communication path reference (indicated by a dotted line), and the accumulated communication states of the third gateway 200c with the service server 100 and all of connected repeaters correspond to a failure-expected communication path reference (indicated by dotted lines).

Such failure-expected communication paths do not mean that there is a communication failure in corresponding paths at the current point in time and are shown by accumulating histories in which the current communication state is good but the communication state was deteriorated in the past, and mean communication sections having a possibility of a failure due to variation of the environment of a construction site (progress of specific work).

When it is expected that a communication failure will be generated in a failure-expected communication path by a communication interference factor derived in accordance with the progress of a scheduled process, the failure response strategy creator creates a communication response strategy through communication setting change of communication equipment of communication elements. When a failure response possibility by only communication setting change is under a reference, the additional-element simulator 185, as shown in the figure, proposes to install an additional repeater 55a on the path between the first gateway 200a and the repeater in the section 1-3 and proposes to install an additional repeater 85a on the path between the second gateway 200b and the service server 100 (substantially on the path for connection of an external communication network 80). For the third gateway 200c, since all of connected communication paths rather than a specific communication path were deteriorated when a failure is generated, the third gateway 200c determines whether power variation of the power meter reader 60b collected in correspondence to a corresponding point in time of communication deterioration is also over a reference, and determines that it is a problem with a power source and proposes to connect an assistant power source 65a, as shown in the figure, when power variation and the communication failure state of the third gateway 200c correspond to each other. The assistant power source may be separate power line, battery, etc. that are separate independent power sources.

The additional-element simulator 185 estimates the communication state of a new communication path prepared after an additional communication element is disposed or an additional power source is disposed (through a neural network learning unit), as described above, thereby creating and providing simulated communication path state information to the communication path management unit 120.

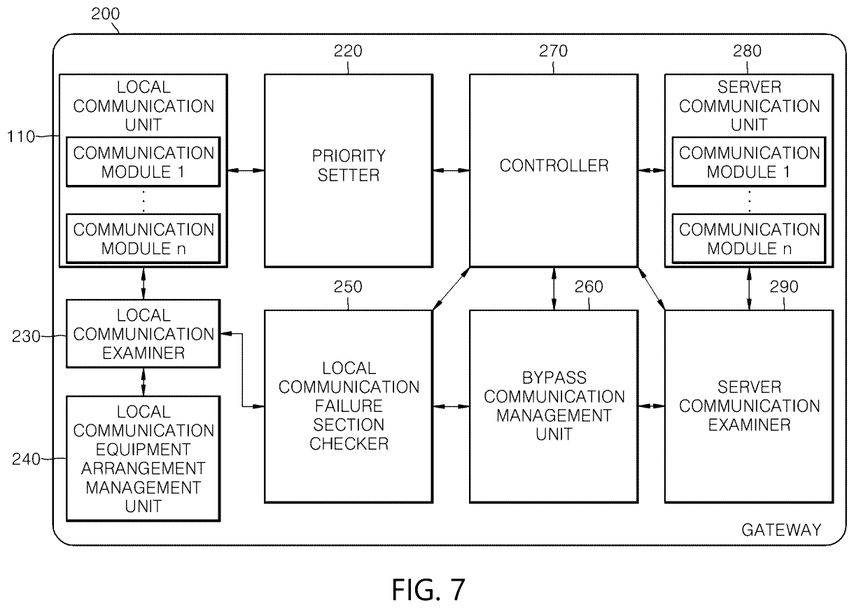

FIG. 7 is an exemplary diagram showing the configuration of a gateway 200 according to an embodiment of the present disclosure. As shown in the figure, the gateway includes: a local communication unit 210 that is connected with communication elements including terminals and repeaters in a construction site by selecting one or more of a plurality of communication methods; a server communication unit 280 that is connected with a service server 100 by selecting one or more of a plurality of communication methods; a local communication examiner 230 that collects the communication state information with a repeater 50 connected in the communication range thereof through the local communication unit 210 and finds out a communication state by periodically checking communication state information with the communication terminal 40 and the repeater 50 through the repeater 50; a server communication examiner 290 that selects and switches to one or more of a plurality of communication methods prepared in accordance with communication quality by checking communication with a server for stable communication with the service server 100 connected through the server communication unit 280 and provides communication state information to the service server; a local communication equipment arrangement management unit 240 that stores arrangement information of communication elements including the repeater 50 and the communication terminal 40 in the communication range thereof; a bypass communication management unit 260 that changes a communication setting into a parameter of failure response strategy information received from the service server 100; and a controller that provides communication state information of the local communication examiner 230 and the server communication examiner 290 to the service server 100 through the server communication unit 280, receives failure response strategy information including a communication interference estimation period and communication setting change parameters from the service server 100, determines whether communication quality deterioration is generated on a communication path during the communication interference estimation period, and provides communication setting parameter information of the failure response strategy information to the bypass communication management unit 260 when communication quality deterioration under a reference is generated.

Meanwhile, the failure response strategy information may include information for changing the priority of a message to be transmitted in priority to the service server 100 of information received from communication elements, and the gateway 200 may further include a priority setter 220 that determines priority for transmission of messages of the communication elements received through the local communication unit 210 and provides messages with higher priority first.

Further, the gateway may further include a local communication failure section checker 250 that creates a failure-expected communication path in accordance with arrangement positions and communication states with communication elements in communication ranges of the local communication equipment arrangement management unit 240 and the local communication examiner 230 and provides the failure-expected communication path to the service server 100 for easy determination of the communication path management unit 120 of the service server 100.

For example, when a shadow gateway 200 finds out the communication state of a repeater 50 in the communication range thereof and the communication state of the repeater 50 disposed at a specific position is poor or frequently changed, the local communication shadow section checker 250 can compute information of the position at which the repeater 50 is disposed (section information, coordinate information, etc.) by itself and transmit the information to the service server 100 through the controller 270.

Further, when the shadow gateway 200 finds out the communication state of the repeater 50 in the communication range thereof and finds out the communication state between the repeater 50 and a communication terminal 40, and the communication state between the repeater 50 and the communication terminal 40 is poor or irregularly changed, the local communication shadow section checker 250 can compute information of the positions at which the repeater 50 and the communication terminal 40 are disposed (section information, coordinate information, etc.) and communication path information by itself and transmit the information to the service server 100 through the controller 270.

The bypass communication management unit 260 changes a communication setting into a parameter of failure response strategy information received from the service server 100 in accordance with control by the controller 270 and the parameter of the failure response strategy information may include setting change parameter information for setting a communication type for bypass or to be maintained and an available communication condition for a specific communication element, setting change parameter information about change of a data format to be transmitted/received, setting change parameter information of prior data type. Accordingly, it is possible to change the communication method of the communication terminal 40 and the repeater 50, change the communication method between the repeaters 50, change the communication method between the repeater 50 and the shadow gateway 200, or change an external communication network connection method for connection of the shadow gateway 200 and the service server 100, and it is possible to change also priority settings of a period of collecting information from communication elements, information to be collected in priority, information to be transmitted in priority to the service server 100 in the collected information, etc.

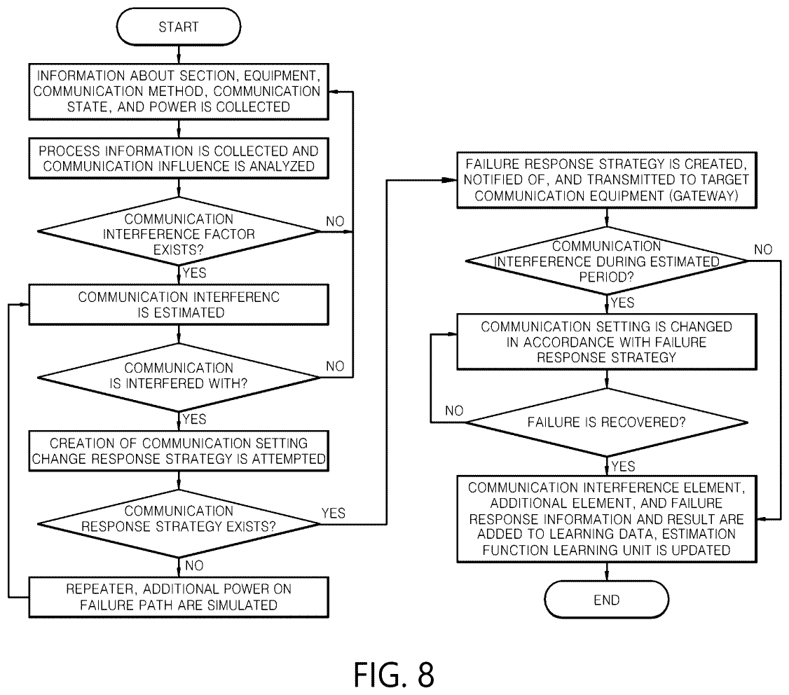

FIG. 8 is a flowchart showing an operation process of a communication network management service based on process information at a construction site according to an embodiment of the present disclosure.

As shown in the figure, first, in an ordinary situation, a service server receives and stores communication state information of a communication path from construction site communication equipment (gateway) and determines a communication failure on the basis of a communication state, thereby determining a failure-expected communication path on the basis of the degree and frequency of the communication failure. Of course, it is also possible to receive local failure-expected communication path information from communication equipment. Further, the service server can receive power state information of power lines for supplying power to communication equipment or communication elements together with time information through a power meter reader, can find out communication state variation information accompanying power variation by comparing the communication states of communication equipment and communication elements on a communication path with the point in time of power state variation, and can reflect the power state variation information to communication path state information.

The service server updates the communication states of construction site communication equipment and communication elements and information about a failure-expected communication path on the basis of the information described above.

Meanwhile, the service server receives process information including physical structure information, construction equipment arrangement information, and work schedule information at a construction site from a process management server periodically or in accordance with state change of the process management server, thereby selecting communication interference elements in each period that will interfere with communication.

When there is a communication interference element, the service server estimates the possibility and degree of the selected communication interference factor interfering with communication of communication equipment or communication elements on a failure-expected communication path determined on the basis of the kinds, arrangement, and communication state information of communication equipment and communication elements configured at a construction site.

When communication interference over a reference is estimated, the service server creates one or more of communication interference estimation period information according to a communication interference factor, failure response strategy information including communication equipment setting change parameter information, and failure response possibility estimation information corresponding to the failure response strategy information. The failure response possibility estimation information may be a failure response possibility estimation probability that is estimated when failure response strategy information is created.

When the failure response possibility estimation information of the created failure response strategy information satisfies a predetermined reference, the failure response strategy information is transmitted to communication equipment on a failure-expected communication path. When a failure response strategy in which the failure response possibility estimation information satisfies the reference is not created, a communication change proposal of adding a repeater on a failure-expected communication path with a communication interference possibility or adding a power source to communication equipment or a communication element on the failure-expected communication path is created and simulated communication path state information for a communication path changed in accordance with the proposal is created.

Communication interference due to a communication interference factor is estimated on the basis of the simulated communication path state information, a failure response strategy information is created again when communication interference over a reference is estimated, and this process is performed again from the process of applying an additional repeater or an additional power source when the failure response possibility estimation information of the created failure response strategy information does not satisfy a predetermined reference.

When the failure response possibility estimation information of the failure response strategy information created after an additional repeater or an additional power source is applied satisfies a predetermined reference, the service server creates the changed communication path information and change proposal information about the added repeater or power source, notifies a manger of the information, receives information showing that the change is completed and information about changed communication elements or power source from the manager, and updates information about existing communication equipment or communication element. Thereafter, failure response strategy information created in correspondence to the changed communication network is transmitted to communication equipment on the failure-expected communication path.

The communication equipment (gateway) receiving the failure response strategy information determines that communication interference has been generated, using communication interference estimation period information included in the received failure response strategy information when the communication state of a failure-expected communication path sensed during the period is deteriorated under a failure reference.

When the communication equipment (gateway) determines that generation of communication interference, a communication method is changed by changing the communication settings of communication equipment or communication elements on the basis of parameter information included in the failure response strategy information and whether the failure has been recovered (the communication state has been recovered over the reference) is determined. Further, when the failure has not been recovered, the communication settings are changed into the next-priority parameter information included in the failure response strategy information.

When the failure is recovered the communication setting change, the communication equipment informs the service server of the parameter information in the failure response strategy information used to recover the failure, and the service server adds the communication interference factor, meaningful parameter information in the failure response information, the recovered communication state information, the communication state information of the added communication elements, etc. as learning data, and updates the details of learning of the estimator for communication interference factor estimation, the estimator for communication interference degree estimation, the estimator applied to create information for failure response strategy creation, and the estimator applied to estimate simulated communication path state information of the additional-element simulator.

It is possible to generally respond to irregular and complex communication interference factors at a construction site through this process and it is possible to increase reliability is communication connection for necessary communication terminals for checking a process, preventing safety accidents, and taking measures against safety accidents.

The management terminal 30, the communication terminal 40, the repeater 50, the gateway 200, and the service server 100 can be implemented as hardware components, software components, and/or combinations of a hardware component and a software component.

Further, the components described in the embodiments can be implemented using one or more common computers or computers for specific purposes, such as a processor, a controller, an ALU (arithmetic logic unit), a digital signal processor, a microcomputer, an FPA (field programmable array), a PLU (programmable logic unit), a microprocessor, or any devices that can execute instructions and give responses.

Meanwhile, the management terminal 30, the communication terminal 40, the repeater 50, the gateway 200, and the service server 100 each may include a communication unit, a storage unit, a display, a sound output unit, a controller, etc.

The communication units included in the management terminal 30, the communication terminal 40, the repeater 50, the gateway 200, and the service server 100 perform communication connection with a certain component therein or at least one certain external terminal through a wired/wireless communication network. In this case, as wireless internet technologies, there are Wireless LAN (WLAN0, Digital Living Network Alliance (DLNA), Wireless Broadband (Wibro), World Interoperability for Microwave Access (Wimax), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), etc., and a communication unit transmits and receives data in accordance with at least one wireless internet technology in a range including even internet technologies not stated above. Further, a near field communication technology may include Bluetooth, Radio Frequency Identification (RFID), Infrared Data Association (IrDA), Ultra Wideband (UWB), Zigbee, Near Field Communication (NFC), Ultra Sound Communication (USC), Visible Light Communication (VLC), Wi-Fi, Wi-Fi Direct, etc. Further, a wired communication technology may include Power Line Communication (PLC), USB communication, Ethernet, serial communication, an optical/coaxial cable, etc.

Further, a communication unit can transmit and receive information to and from a certain terminal through a Universal Serial Bus (USB).

Further, a communication unit can transmit/receive radio signals to/from the management server 30, the communication terminal 40, the repeater 50, the gateway 200, the service server 100, etc. on a mobile communication network constructed in accordance with technical standards and communication types for mobile communication (e.g., GSM (Global System for Mobile communication), CDMA (Code Division Multi Access), CDMA2000 (Code Division Multi Access 2000), EV-DO (Enhanced Voice-Data Optimized or Enhanced Voice-Data Only), WCDMA (Wideband CDMA), HSDPA (High Speed Downlink Packet Access), HSUPA (High Speed Uplink Packet Access), LTE (Long Term Evolution), and LTE-A (Long Term Evolution-Advanced)).

A storage unit (memory) that may be included in the management server 30, the communication terminal 40, the repeater 50, the gateway 200, and the service server 100 stores various user interfaces (UI), graphic user interfaces (GUI), etc.

Further, the storage unit stores data, programs, etc. for operation of the management server 30, the communication terminal 40, the repeater 50, the gateway 200, and the service server 100.

That is, the storage unit can store many application programs (or applications) that are executed in the management server 30, the communication terminal 40, the repeater 50, the gateway 200, and the service server 100, and data and commands for operation. At least some of the application programs can be downloaded from an external service provision device through wireless communication. Further, at least some of the application programs may exist in the management server 30, the communication terminal 40, the repeater 50, the gateway 200, the service server 100, etc. from the point in time of releasing for fundamental functions (e.g., a function of receiving and making a call and a function of receiving and sending a message). Meanwhile, application programs are stored in the storage unit and installed in the management server 30, the communication terminal 40, the repeater 50, the gateway 200, the service server 100, etc., thereby being able to be executed to perform operation (or functions).

Further, the storage unit may include at least one storage medium of flash memory type, hard disk type, multimedia card micro type, card type memories (e.g., an SD or XD memory), a magnetic memory, a magnetic disc, an optical disc, a RAM (Random Access Memory) an SRAM (Static Random Access Memory), a ROM (Read-Only Memory), an EEPROM (Electrically Erasable Programmable Read-Only Memory), and a PROM (Programmable Read-Only Memory). Further, the management terminal 30, the service server 100, etc. may operate a web storage that performs the storage function of a storage unit on the internet or may operate in relation to the web storage.

The display that can be included in the management server 30, the communication terminal 40, the repeater 50, the gateway 200, and the service server 100 can display various contents such as various menu images using the user interface and/or the graphic user interface stored in the storage unit by control of an internal control unit. In this case, the contents that are displayed on the display include various text or image data (including various information data) and data such an icon, a list menu, and a combo box. Further, the display may be a touch screen.

Further, the display may include at least one of a Liquid Crystal Display (LCD), a Thin Film Transistor-Liquid Crystal Display (TFT LCD), an Organic Light Emitting Diode (OLED), a flexible display, a 3D display, an e-ink display, and a Light Emitting Diode (LED).

Further, the display may be configured as a 3D display that displays 3D images.

3D display types such as stereoscopic type (glasses type), an auto-stereoscopic type (non-glasses type), and a projection type (holographic type) may be applied to the 3D display.

The sound output unit that can be included in the management server 30, the communication terminal 40, the repeater 50, the gateway 200, and the service server 100 outputs sound information included in a signal that has undergone predetermined signal processing by a control unit. In this case, the sound output unit may include a receiver, a speaker, a buzzer, etc.

Further, the sound output unit can output a guide voice created by a controller.

The control unit that can be configured in the management server 30, the communication terminal 40, the repeater 50, the gateway 200, and the service server 100 performs general control functions. In this case, the control unit may be a processor or an engine.

Further, the control unit performs general control functions using the programs and data stored in the storage unit. The control unit may include a RAM, a ROM, a CPU, a GPU, and a bus, and the RAM, the CPU, the GPU, etc. may be connected to each other through the bus. The CPU can access the storage unit and perform booting using an O/S stored in the storage unit, and can perform various operations using various programs, contents, data, etc. stored in the storage unit.

Further, the management server 30, the communication terminal 40, the gateway 200, and the service server 100 may further include an interface unit (not shown) that functions as an interface with all of connected external devices. For example, the interface unit may be a wired/wireless headset port, an external charger port, a wire/wireless data port, a memory card port, a port connecting a device equipped with an identification module, an audio I/O (Input/Output) port, a video I/O (Input/Output) port, an earphone port, etc. In this case, the identification module is a chip storing various items of information of authenticate the right of use and may include a User Identity Module (UIM), a Subscriber Identity Module (SIM), a Universal Subscriber Identity Module (USIM), etc. Further, a device equipped with the identification module may be manufactured in a smart card type. The interface unit receives data or power from an external device such that the data or power is transmitted to the components in the device or data in the device is transmitted to the external device.

Further, when the repeater 50 or the communication terminal 40 is connected with an external cradle, the interface unit may be a passage through which power is supplied to the terminal or a passage through which various instruction signals input from the cradle by a user are transmitted to the terminal. The various instruction signals or the power that is input from the cradle may operate as signals for recognizing that a terminal has been accurately mounted on the cradle.

Further, the management server 30, the communication terminal 40, the repeater 50, the gateway 200, and the service server 100 may further include an input unit (not shown) for receiving a signal according to button operation or selection of a certain function by a user or for receiving an instruction or a control signal created by operation such touching/scrolling a displayed image.

The input unit is a unit for receiving at least one of instructions, selection, data, and information by a user and may include several input keys and function keys for receiving number or character information and setting various functions.

Further, as the input unit, various devices such as a key pad, a dome switch, a (static pressure/electrostatic) touch pad, a touch screen, a jog wheel, a jog switch, a jog shuttle, a mouse, a stylus pen, and a touch pen may be used. In particular, when the display is formed in a touch screen type, some or all of input functions can be performed through the display.

Further, the components (or modules) of the management terminal 30, the communication terminal 40, the repeater 50, the gateway 200, and the service server 100 may be software stored in the memory (or storage unit) of the devices. The memory may be an internal memory of a device and may be an external memory or other types of memory device. Further, the memory may be a nonvolatile memory. Software stored in the memory may include a set of commands that makes a device perform specific operation when it is executed.

Further, the service server 100 may be implemented in types of a web server, a database server, a proxy server, etc. Further, a network load distribution mechanism and one or more of various items of software that enables the service server 100 to operate on the internet or other networks may be installed in the service server 100, whereby the service server 100 may be implemented as a computerized system. Further, a network may be an http network and may be a private line, an intranet, or other certain networks. Further, the management server 30, the communication terminal 40, the repeater 50, the gateway 200, and the service server 100 may be connected through a security network so that data is not attacked by certain hackers or other third persons. Further, the service server 100 may include a plurality of database servers and the database servers may be separately connected with the service server 100 through a certain type of network connection including a distribution database server architecture.

Further, a processor mounted in the management server 30, the communication terminal 40, the repeater 50, the gateway 200, and the service server 100 according to the present disclosure can process program instructions for executing a method according to the present disclosure. The processor may be a single-threaded processor in an embodiment and the processor may be a multi-threaded processor in another embodiment. Further, the processor can process instructions stored in a memory or a storage device.

Further, the management terminal 30, the communication terminal 40, the repeater 50, the gateway 200, and the service server 100 may access, store, operate, process, and create data in response to execution of software.

For the convenience of understanding, components each were described as being used as a single part, but those skilled in the art can understand that the processor may include a plurality of processing elements and/or a plurality of types of processing elements.

For example, the management terminal 30, the communication terminal 40, the repeater 50, the gateway 200, and the service server 100 may include a plurality of processors, or one processor and one controller. Further, other processing configurations such as parallel processors are also possible.

Software may include a computer program, a code, an instruction, or one or more combinations thereof, and may make the management server 30, the communication terminal 40, the repeater 50, the gateway 200, and the service server 100 operate as desired or may give instructions independently or collectively to them.

Software and/or data may be embodied permanently or temporarily in any types of machine, component, physical device, virtual equipment, and computer storage medium or device, or a transmitted signal wave to be analyzed by the management server 30, the communication terminal 40, the repeater 50, the gateway 200, and the service server 100 or to provide instructions or data to the management server 30, the communication terminal 40, the repeater 50, the gateway 200, and the service server 100.

Software may be distributed to computer systems connected through a network and stored or executed in the distributed way. Software and data can be recorded on one or more computer-readable recording media.

The communication failure response service method based on a schedule at a construction site according to an embodiment of the present disclosure described above can be constructed as a computer program, and codes and code segments constituting the computer program can be easily inferred by computer programmers in the field. Further, the computer program is stored in computer readable media and is read out and executed by a computer or the management server 30, the communication terminal 40, the repeater 50, the gateway 200, and the service server 100 according to an embodiment of the present disclosure, whereby it is possible to implement the communication failure response service method based on a schedule at a construction site according to an embodiment of the present disclosure.

The computer readable media include a magnetic recording medium and an optical recording medium. The computer program that implements the communication failure response service method based on a schedule at a construction site according to an embodiment of the present disclosure may be analyzed by the management server 30, the communication terminal 40, the repeater 50, the gateway 200, and the service server 100 or may be stored and installed in a built-in memory of the management server 30, the communication terminal 40, the repeater 50, the gateway 200, and the service server 100. Alternatively, an external memory such as a smart card in which the computer program that implements the communication failure response service method based on a schedule at a construction site according to an embodiment of the present disclosure is stored and installed may be mounted in the management server 30, the communication terminal 40, the repeater 50, the gateway 200, and the service server 100 through an interface.

Various devices and components described herein may be achieved by a hardware circuit (e.g., a CMOS-based logic circuit), firmware, software, or a combination thereof. For example, they may be achieved by using transistors, logic gates, and electronic circuits in various electrical structures.

The above description may be changed and modified by those skilled in the art without departing from the fundamental characteristics of the present disclosure. Accordingly, the embodiments described herein are provided merely not to limit, but to explain the spirit of the present disclosure, and the spirit of the present disclosure is not limited by the embodiments. The protective range of the present disclosure should be construed by the following claims and the scope and spirit of the present disclosure should be construed as being included in the range of right of the present disclosure.

### DESCRIPTION OF REFERENCE NUMERALS

10: BUILDINGS
20: SHADOW AREAS
30: MANAGEMENT TERMINAL
40: COMMUNICATION TERMINAL
50: REPEATER
55: ADDITIONAL REPEATER
60: POWER METER READER
80: EXTERNAL COMMUNICATION NETWORK
85: ADDITIONAL REPEATER
100: SERVICE SERVER
110: COMMUNICATION UNIT
120: COMMUNICATION PATH MANAGEMENT UNIT
130: COMMUNICATION ELEMENT INFORMATION MANAGEMENT UNIT
140: CONSTRUCTION INFORMATION COLLECTOR
150: COMMUNICATION INFLUENCE ANALYZER
160: LEARNING DATA COLLECTOR
170: COMMUNICATION FAILURE ESTIMATOR
180: FAILURE RESPONSE STRATEGY CREATOR
185: COMMUNICATION FAILURE ESTIMATOR
190: CONTROLLER
200: SHADOW GATEWAY
210: LOCAL COMMUNICATION UNIT
220: PRIORITY SETTER
230: LOCAL COMMUNICATION EXAMINER
240: LOCAL COMMUNICATION EQUIPMENT ARRANGEMENT MANAGEMENT UNIT
250: LOCAL COMMUNICATION FAILURE SECTION CHECKER
260: BYPASS COMMUNICATION MANAGEMENT UNIT
270: CONTROLLER
280: SERVER COMMUNICATION UNIT
290: SERVER COMMUNICATION EXAMINER
300: PROCESS MANAGEMENT SERVER

What is claimed is:

1. A device for a communication failure response service based on process information at a construction site, the device comprising:
a communication influence analyzer configured to select a communication failure factor in each period by receiving process information comprising physical structure information, construction equipment arrangement information, and work schedule information at the construction site;
a communication path management unit configured to:
receive communication state information of communication elements constituting a communication network from communication equipment in the construction site,
create communication path state information reflecting the communication state information to kind and arrangement information of communication equipment and communication elements prepared in advance in the construction sites, and
determine a failure-expected communication path based on the communication state information; and
a failure response strategy creator configured to create and transmit one or more items of failure response strategy information, which comprises a setting change parameter of the communication equipment in the construction site, to communication equipment on the failure-expected communication path in correspondence to communication interference factor information of the communication influence analyzer.

2. The device of claim 1, further comprising:
a communication unit configured to:
transmit and receive information to and from the communication equipment at the construction site,
receive communication state information of communication elements comprising a repeater and a communication terminal connected to the communication equipment from the communication equipment, and
receive construction site process information by communicating with a processor management server; and
a communication element information management unit configured to:
have the kind and arrangement information of the communication equipment and the communication elements at the construction site,
collect communication state information of the communication equipment and communication elements at the construction site received through the communication unit, and
provide the communication state information to the communication path management unit.

3. The device of claim 2, further comprising a communication interference estimator configured to:
learn communication state information according to arrangement positions and communication paths at the construction site of communication equipment and communication elements constituting a construction site communication network and communication interference factor information of the communication influence analyzer through the communication element information management unit and the communication path management unit,
estimate communication interference degrees of communication equipment and communication elements on a communication path due to a communication interference factor, and
provide a result of the estimation to the failure response strategy creator.

4. The device of claim 2, wherein the communication influence analyzer learns communication state information of communication equipment and communication elements at each arrangement position at the construction site of the communication element information management unit, thereby estimating a communication interference element, a communication interference degree, and a communication interference period that change communication states of the communication equipment or the communication elements in the physical structure information, the construction equipment arrangement information, and the work schedule information at the construction site included in the process information.

5. The device of claim 1, wherein the failure response strategy creator creates one or more items of failure response strategy information comprising at least one item of information of setting change parameter information for setting a communication type for bypass or to be maintained and an available communication condition when a communication state becomes under a reference, setting change parameter information about change of data format to be transmitted and received, and setting change parameter information of a high-priority data type, together with communication interference estimation period information according to the process information.

6. A device for a communication network management service based on process information at a construction site, the device comprising:
a communication influence analyzer configured to select a communication failure factor in each period by receiving process information comprising physical structure information, construction equipment arrangement information, and work schedule information at the construction site;
a communication path management unit configured to:
receive communication state information of communication elements constituting a communication network from communication equipment in the construction site,
create communication path state information reflecting the communication state information to kind and arrangement information of communication equipment and communication elements prepared in advance in the construction sites, and
determine a failure-expected communication path based on the communication state information;
a failure response strategy creator configured to:
create one or more items of failure response strategy information, which comprises a setting change parameter of communication equipment on a failure-expected communication path according to communication interference factor information of the communication influence analyzer, together with failure response possibility estimation information, and
transmit failure response strategy information having a failure response possibility over a reference; and
an additional-element simulator configured to create and provide simulated communication path state information, in which an additional communication element is applied to a failure-expected communication path, to the communication path management unit when the failure response strategy creator cannot create failure response strategy information having a failure response possibility over the reference.

7. The device of claim 6, wherein the communication path management unit receives power information of power that is supplied to construction site communication equipment and communication element and applies the power information when selecting a communication interference factor in each period, and the additional-element simulator further applies an additional power source to communication equipment and a communication element on a failure-expected communication path when creating simulated communication path state information.

8. A system for a communication failure response service based on process information at a construction site, the system comprising:
a service server configured to:
select a communication failure factor that will interfere with communication in each period by receiving process information comprising physical structure information, construction equipment arrangement information, and work schedule information at the construction site,
create communication path state information reflected to kind and arrangement information of communication equipment and communication elements in the construction site and then determine a failure-expected communication path by receiving communication state information of the communication elements constituting a communication network from the communication equipment in the construction site, and
create and transmit failure response strategy information, which comprises communication interference expectation period information according to the communication interference factor and communication equipment setting change parameter information, to communication equipment on an failure-expected communication path; and
communication equipment configured to:
be connected with the service server through one of a plurality of communication methods,
be connected to communication elements comprising a terminal and a repeater in the construction site through one of a plurality of communication methods,
transmit communication state information with the service server and communication state information with communication elements to the service server,
receive failure response strategy information provided from the service server, and
change a communication setting thereof into a parameter of the failure response strategy information or provide communication setting change information to the communication elements when actual communication interference is found out during a communication interference expectation period.

9. The system of claim 8, wherein the communication equipment further comprises a server communication examiner configured to:
select and switch to one or more of a plurality of communication methods prepared in accordance with communication quality by checking communication with a service server for stable communication with the service server, and
provide communication state information to the service server.

10. The system of claim 8, wherein the communication equipment further comprises:
a local communication examiner configured to find out a communication state by periodically checking communication with communication elements in a communication range thereof;
a local communication equipment arrangement management unit configured to store arrangement information of communication elements in a communication range thereof;
a bypass communication management unit configured to change a communication setting into a parameter of failure response strategy information received from the service server; and
a local communication failure section checker configured to create and provide local communication failure section information to the service server in accordance with a communication state with and arrangement positions of communication elements in the communication ranges of the local communication equipment arrangement management unit and the local communication examiner.
